(19) United States
(12) Patent Application Publication
(10) Pub. No.: US 2014/0236676 A1
(43) Pub. Date: Aug. 21, 2014

(54) SYSTEM FOR PROVIDING CONSUMER RATINGS

(71) Applicants: Marie B. V. Olesen, La Jolla, CA (US); Dana Fox, Edmonds, WA (US); David Evans, La Jolla, CA (US); April K. Linden, San Diego, CA (US); Eva K. Sheie, North Bend, WA (US); Aimee Ellingsen, Asheville, NC (US)

(72) Inventors: Marie B. V. Olesen, La Jolla, CA (US); Dana Fox, Edmonds, WA (US); David Evans, La Jolla, CA (US); April K. Linden, San Diego, CA (US); Eva K. Sheie, North Bend, WA (US); Aimee Ellingsen, Asheville, NC (US)

(21) Appl. No.: 14/180,340

(22) Filed: Feb. 13, 2014

Related U.S. Application Data
(60) Provisional application No. 61/765,648, filed on Feb. 15, 2013.

(51) Int. Cl. G06Q 30/02

(52) U.S. Cl. CPC G06Q 30/0282; G06Q 30/0203
USPC 705/7.32

(57) ABSTRACT

A technique of providing consumer ratings relates to the requesting from providers, consumer contact information for consumers receiving goods and/or services from the providers by an independent third-party rating service. In response to receiving the consumer contact information, sending of survey questionnaires to the consumers may then be accomplished. The independent third-party rating service may then cause the compiling of the survey results, and then may display on its third-party website the consumer ratings for the actual consumers who have received the goods and/or services. The third-party rating service may supply to the provider computers the ratings or reviews from the surveyed consumers. Sub-categories may also be searched.

### RELATED APPLICATION

The present patent application is related to U.S. patent application entitled SYSTEM FOR PROVIDING CONSUMER RATINGS, filed Feb. _____, 2014, and assigned application Ser. No. _____, which is incorporated herein by reference as if set forth herein in its entirety.

### FIELD OF THE INVENTION

The present invention relates in general to a method for providing consumer ratings. It more particularly relates to a method for providing more accurate and trustworthy consumer ratings for advising others such as the public in general concerning a variety of goods and/or services.

### BACKGROUND ART

This section describes the background art of the disclosed embodiment of the present invention. There is no intention, either express or implied, that the background art discussed in this section legally constitutes prior art.

Modernly, providers of goods and services oftentimes promote their products and services on websites. The providers will frequently request reviews and surveys pertaining to their products and services.

However, frequently the reviews and survey results are not entirely trustworthy. In this regard, all too frequently competitors or others may respond in a negative manner. Thus, when the provider publishes on its own website the results of the surveys and reviews, the results may not always be taken very seriously by the general public seeking to acquire the goods and/or services from the provider. The general public may be adversely affected by the false responses and thus tend not to purchase the goods or services from the provider. Also, when the provider receives substantially all raving reviews and/or ratings, the potential consumer may think that the reviews are not authentic or have been unfairly selected by the provider who may have deliberately eliminated adverse or unfavorable reviews. As a result, the potential consumer may not be persuaded to purchase the offered goods or services, or otherwise ignore the reviews entirely.

Therefore, it would be highly desirable to have a new and improved methods and system for providing more accurate and trustworthy ratings for goods or services.

Further drawbacks to conventional rating systems by providers of goods and/or services relate to the fact that generalized ratings of the providers cells may be misleading. Typically, a provider will have a variety of different types and kinds of services and/or products. Therefore a rating for a provider may not be representative of all of its services and/or products. Some of the products and/or services may be of higher quality than other ones of the products and/or services being offered by a given provider. Therefore, a rating for a given provider may not be sufficient information for a consumer because it does not pertain to each and every one of the goods and/or services offered by a given provider.

### BRIEF DESCRIPTION OF THE DRAWINGS

In order to better understand the invention and to see how the same may be carried out in practice, non-limiting preferred embodiments will now be described with reference to the accompanying drawings, in which:

FIG. 1. is a block diagram view of a system, which is constructed in accordance with an embodiment;

FIG. 2 is a block diagram view of another system, which is constructed in accordance with another embodiment;

FIG. 3 is a flowchart diagram of a partially manual method carried out by the system of FIG. 2;

FIG. 4 is a flowchart diagram of a more fully automatic method for carrying out the system of FIG. 2;

FIGS. 5 and 6 are flow diagrams to illustrate the method for carrying out the system of FIG. 2;

FIG. 7 is a screen shot utilized in connection with the method carried out by the system of FIG. 2;

FIGS. 8 and 9 are tables useful in understanding the embodiment of FIG. 2;

FIGS. 10 through 15 are screen shots utilized in connection with the method carried out by the system of FIG. 2;

FIGS. 16 and 17 are flow charts of the method for providing consumer ratings using the system of FIG. 1; and

FIGS. 18, 19 and 20 are screenshots utilized in connection with other features of embodiments carried out by the system of FIG. 2.

### CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of certain ones of the embodiments of the system, components and method of the present invention, as represented in the drawings, is not intended to limit the scope of the invention, as claimed, but is merely representative of the embodiment of the invention.

According to certain embodiments, a method is provided to create and display consumer ratings in a more trustworthy and accurate manner. The ratings are generated by obtaining contact information from actual consumers by an independent third-party rating service, and then sending surveys to the actual consumers only and not to the general public or the providers. In this manner, the general public, as well as the goods and service providers, are not permitted to respond to the surveys, only actual consumers of the goods and/or services. Therefore fake or unreliable responses are totally eliminated or greatly reduced.

A technique of providing consumer ratings relates to the requesting from providers, consumer contact information for consumers receiving goods and/or services from the providers by an independent third-party rating service. In response to receiving the consumer contact information, sending of survey questionnaires to the consumers may then be accomplished. The independent third-party rating service may then cause the compiling of the survey results, and then may display on its third-party website the consumer ratings for the actual consumers who have received the goods and/or services. The third-party rating service may supply to the provider computers the ratings or reviews from the surveyed consumers. Sub-categories may also be searched.

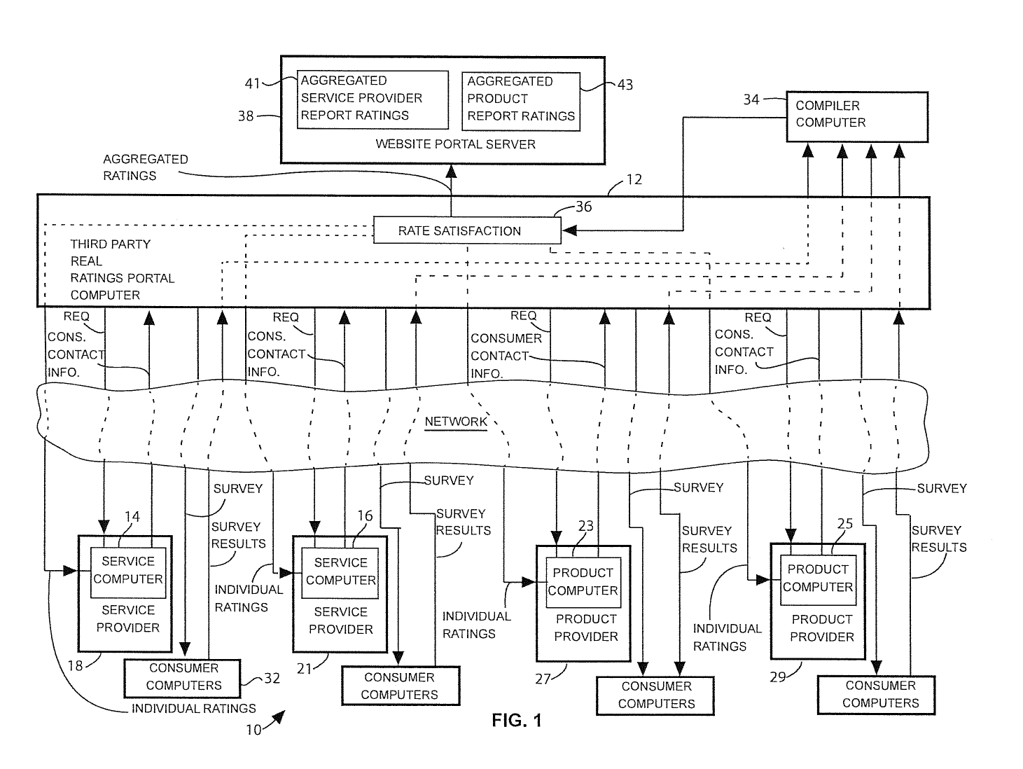

Referring now to the drawings and more particularly to FIG. 1 thereof, there is shown a consumer rating system 10, which is constructed in accordance with an embodiment. The system 10 includes a third party real ratings portal computer 12, which may communicate with a group of service provider computers such as service computer 14 and service computer 16 for the respective service providers 18 and 21. It should be understood that the service providers may be in the same field such as the cosmetic surgery field, or may be in diverse independent and distinct service fields which are totally unrelated to one another.

Similarly, the third party real ratings portal computer 12 may communicate with a group of product computers such as product computer 23 and product computer 25 utilized by respective product providers 27 and 29. The products associated with the product providers 27 and 29 may also be in the same field, or may be totally diverse independent and distinct products.

Considering now the method of utilizing the system 10, the third party real ratings portal computer 12 sends requests signals to the various different service and product computers, such as the service computer 14, to request consumer contact information. The service and product computers then return the consumer contact information for the service and product providers for actual consumers only.

Surveys are then sent via emails or other suitable communication techniques to various different consumer computers such as the consumer computers 32 owned by consumers of services rendered by the service provider 18. The consumers then respond to the surveys and send them back via emails or other suitable communication techniques to the real ratings portal computer 12, which then conveys the raw data to a compiler computer 34, which then compiles the raw data and formats it. A great satisfaction module 36 of the third party real ratings portal computer 12 then generates ratings such as star ratings.

The ratings are then sent to a website portal server 38 which then publishes dynamically as the surveys are collected. In this regard, the website portal server 38 may publish both service provider ratings 41 and product provider ratings 43. For example, the ratings such as star ratings may be published on the website generated by the server 38 on a per provider or per group basis, or on a per procedure or task or product basis.

Also, the portal computer 12 also may provide ratings as well as other information to various service and product computers such as the service computer 14 so that the service and product providers such as the service provider 18 may display individual ratings and/or reviews on the provider's own website. For example, the individual providers may provide information concerning individual practitioners, groups or companies.

In the preferred embodiments, the surveys are maintained anonymously to preserve confidentiality. However, the consumer may choose to provide a review as part of the information supplied to the portal computer 12.

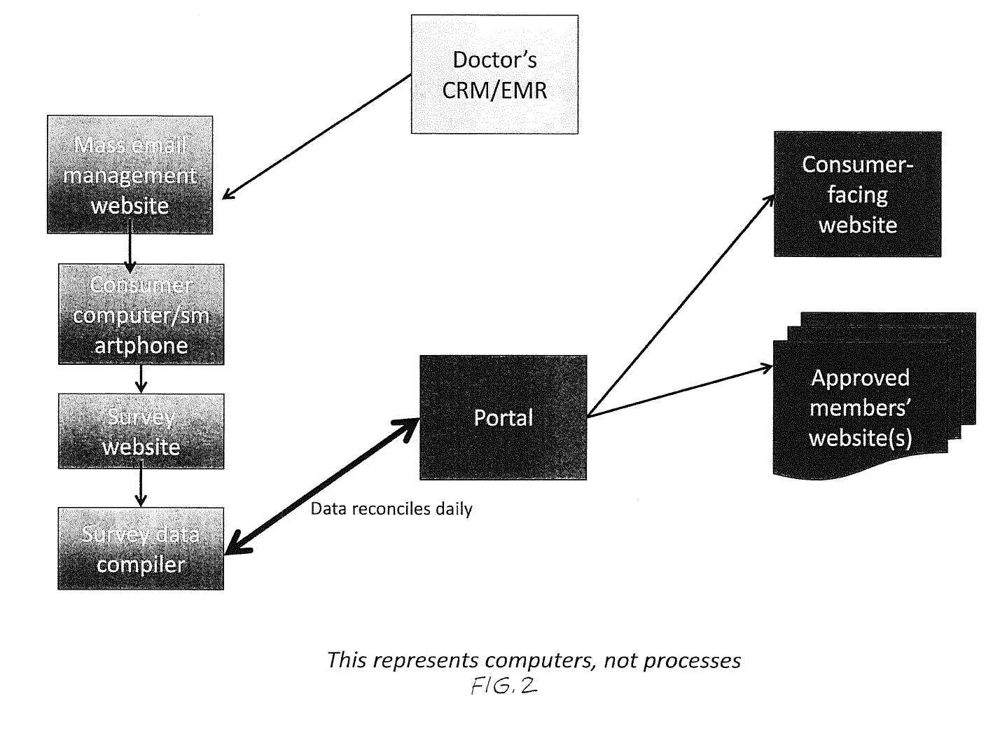

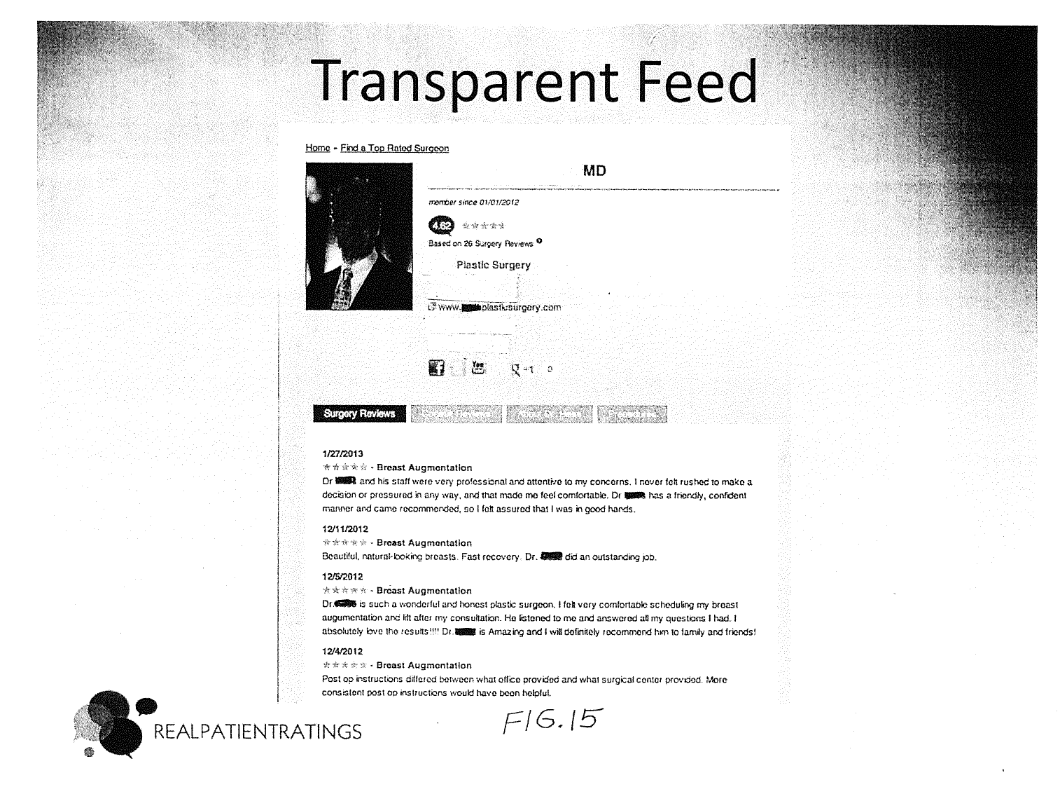

Referring now to FIGS. 2 through 15, there is shown a specific embodiment of the system and method of FIG. 1. The system and method of FIGS. 2 through 15 relate in general to a group of service providers in the cosmetic surgery field.

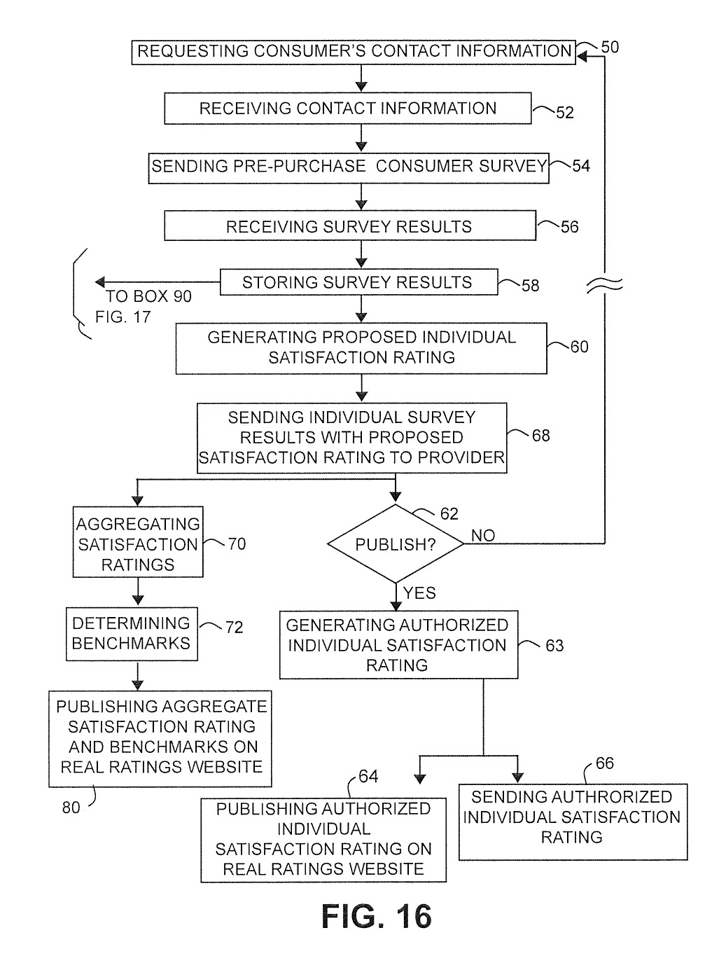

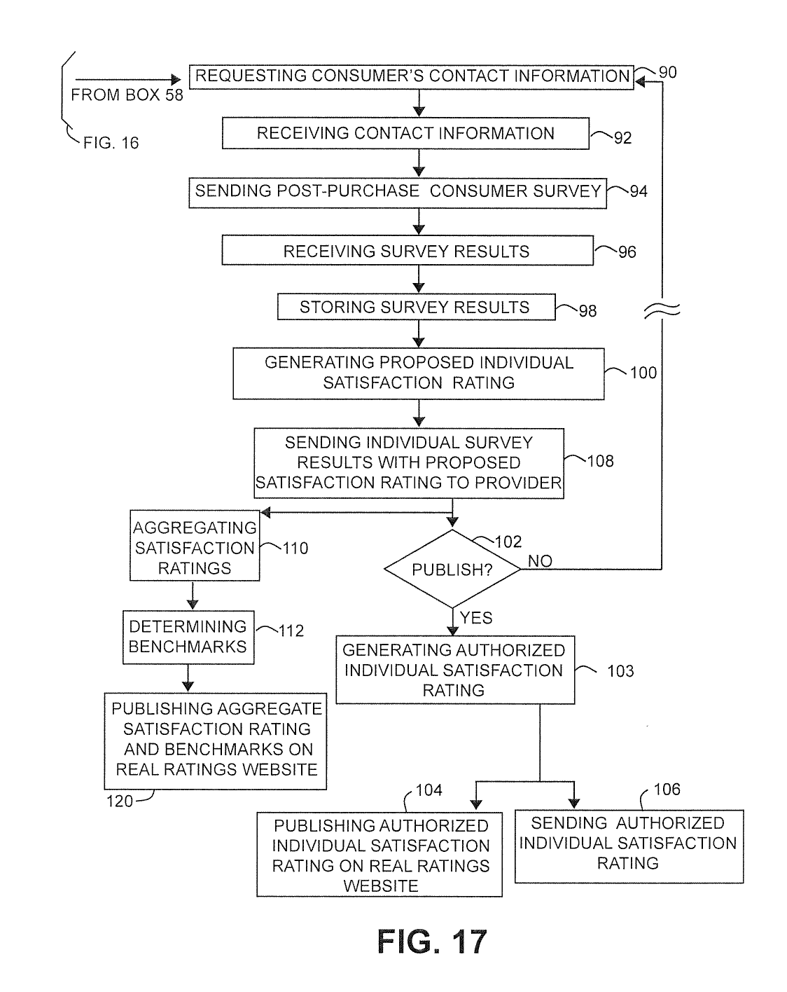

Referring now to FIGS. 16 and 17, there is shown a generalized method for providing consumer ratings using the system of FIG. 1. At box 50, the third party real ratings computer 12 requests consumer contact information from the service provider computer 14. This same generalized method also applies to requests for consumer contact information from the service provider computer 16, the product provider computer 23 and the product provider computer 25. This is contact information from actual consumers who have received a pre-purchase consultation from the service provider 18. For example, the actual consumers might be potential patients who have received a pre-procedure consultation from a physician for a medical treatment such as cosmetic nose surgery. This generalized method also applies to pre-purchase consultations from the service provider 21, the product provider 27 and the product provider 29. At box 52, the service provider computer 14 then returns the consumer contact information for the service provider 18 for actual consumers only.

At box 54, surveys are sent via emails or other suitable communication techniques to various different consumer computers 32 owned by consumers of services rendered by the service provider 18. In the example, these surveys may include questions related to topics such as the patient's overall assessment of the doctor or the patient's likelihood to engage the doctor to actually perform the procedure. The actual consumers then respond to the surveys and send them back via emails or other suitable communication techniques to the real ratings portal computer 12 at box 56. The real ratings portal computer 12 stores the survey results at box 58 by conveying the raw data to the compiler computer 34, which compiles and formats the raw data. Additionally, at box 58, the real ratings portal computer schedules a follow-up post-procedure survey for the consumers who participated in the pre-procedure survey. At box 60, a great satisfaction module 36 of the third party real ratings portal computer 12 then generates a proposed individual satisfaction rating, such as a star rating.

At box 68, the third party real ratings portal computer 12 sends the proposed individual satisfaction rating to the service provider computer 14. At box 62, the service provider 18 reviews and then decides whether to publish the proposed individual satisfaction rating. If the service provider 18 decides not to publish the proposed individual satisfaction rating, then the rating will not be published and the service provider may then review its procedures with this particular actual consumer, or additionally, with other actual consumers in order to try and improve the rating of the service provider 18.

If the service provider 18 decides to publish the rating, the third party real ratings portal computer 12 then generates an authorized individual satisfaction rating at box 63. Then, the third party real ratings portal computer 12 publishes the authorized individual satisfaction rating on the website portal server 38 at box 64. In addition, at box 66, the third party real ratings portal computer 12 sends the authorized individual satisfaction rating to the service provider computer 14 for use and/or publication by the service provider 18 on the service provider's website (not shown).

Once the real ratings portal computer 12 has created proposed individual satisfaction ratings for multiple service providers, such as service provider 18 and service provider 21, then the real ratings portal computer 12 begins to generate aggregate satisfaction ratings at box 70. The real ratings portal computer 12 may also determine benchmarks at box 72. These benchmarks may compare aggregate satisfaction ratings for various categories or geographical areas, such as the western or the northeastern United States. Finally, the real ratings portal computer 12 may publish the aggregate satisfaction ratings and/or the benchmarks based on the pre-purchase surveys provided by actual consumers on the website portal server 38 at box 80.

As described above at box 58, if a consumer who was identified by the real ratings portal computer 12 for participating in the pre-procedure survey and scheduled to receive a follow-up post-procedure survey, the real ratings portal computer 12 then requests updated consumer contact information from the service provider computer 14 at box 90. This is contact information from actual consumers who purchased a service from the service provider 18. For example, the actual consumers might be patients who have received a procedure such as cosmetic nose surgery from a physician. This generalized method also applies to pre-purchase consultations from the service provider 21, the product provider 27 and the product provider 29. At box 92, the service provider computer 14 then returns the consumer contact information for the service provider 18 for actual consumers only.

At box 94, surveys are sent via emails or other suitable communication techniques to various different consumer computers 32 owned by consumers of services rendered by the service provider 18. In the example, these surveys may include questions related to topics such as the patient's overall assessment of the doctor or the patient's likelihood to engage the doctor to perform a different procedure. The actual consumers then respond to the surveys and send them back via emails or other suitable communication techniques to the real ratings portal computer 12 at box 96. The real ratings portal computer 12 stores the survey results at box 98 by conveying the raw data to the compiler computer 34, which compiles and formats the raw data. Additionally, at box 58, the real ratings portal computer schedules a follow-up post-procedure survey for the consumers who participated in the pre-procedure survey. At box 100, a great satisfaction module 36 of the third party real ratings portal computer 12 then generates a proposed individual satisfaction rating, such as star rating.

At box 108, the third party real ratings portal computer 12 sends the proposed individual satisfaction rating to the service provider computer 14. At box 102, the service provider 18 reviews and then decides whether to publish the proposed individual satisfaction rating. If the service provider 18 decides not to publish the proposed individual satisfaction rating, then the rating will not be published and the service provider may then review his procedures with this particular actual consumer, or additionally, with other actual consumers in order to try and improve the service provider's 18 rating.

If the service provider 18 decides to publish the rating, the third party real ratings portal computer 12 then generates an authorized individual satisfaction rating at box 103. Then, the third party real ratings portal computer 12 publishes the authorized individual satisfaction rating on the website portal server 38 at box 104. In addition, at box 106, the third party real ratings portal computer 12 sends the authorized individual satisfaction rating to the service provider computer 14 for use and/or publication by the service provider 18 on the service provider's website (not shown).

Once the real ratings portal computer 12 has created proposed individual satisfaction ratings for multiple service providers, such as service provider 18 and service provider 21, then the real ratings portal computer 12 begins to generate aggregate satisfaction ratings at box 110. The real ratings portal computer 12 may also determine benchmarks at box 112. These benchmarks may compare aggregate satisfaction ratings for various categories or geographical areas, such as the western or the northeastern United States. Finally, the real ratings portal computer 12 may publish the aggregate satisfaction ratings and/or the benchmarks based on the pre-purchase surveys provided by actual consumers on the website portal server 38 at box 120.

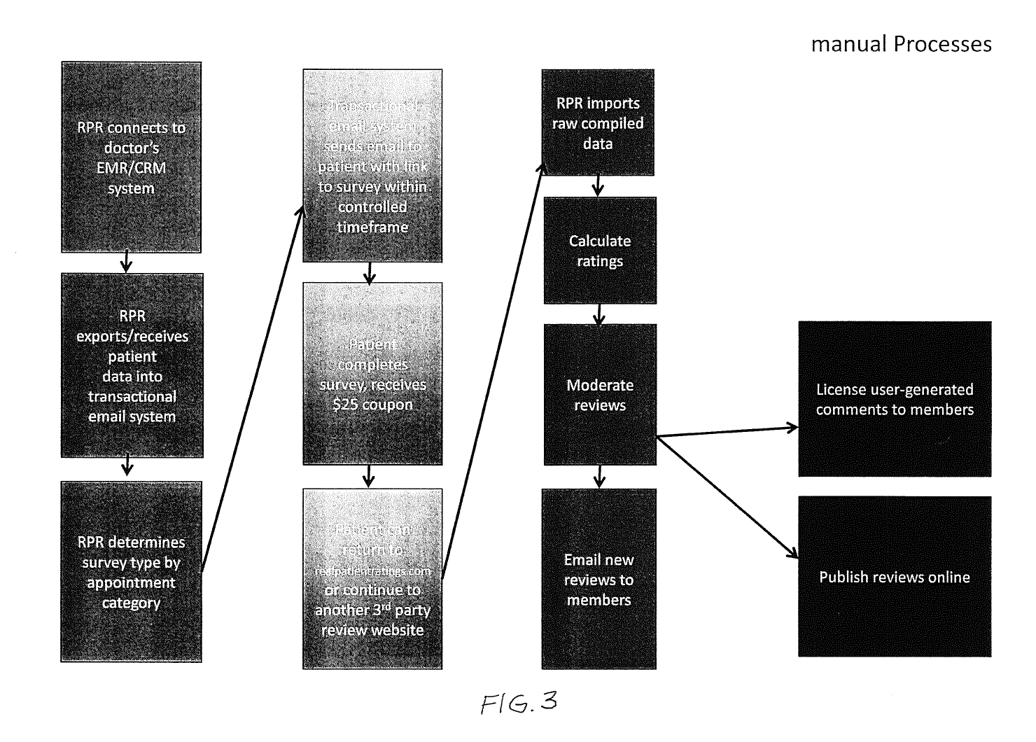

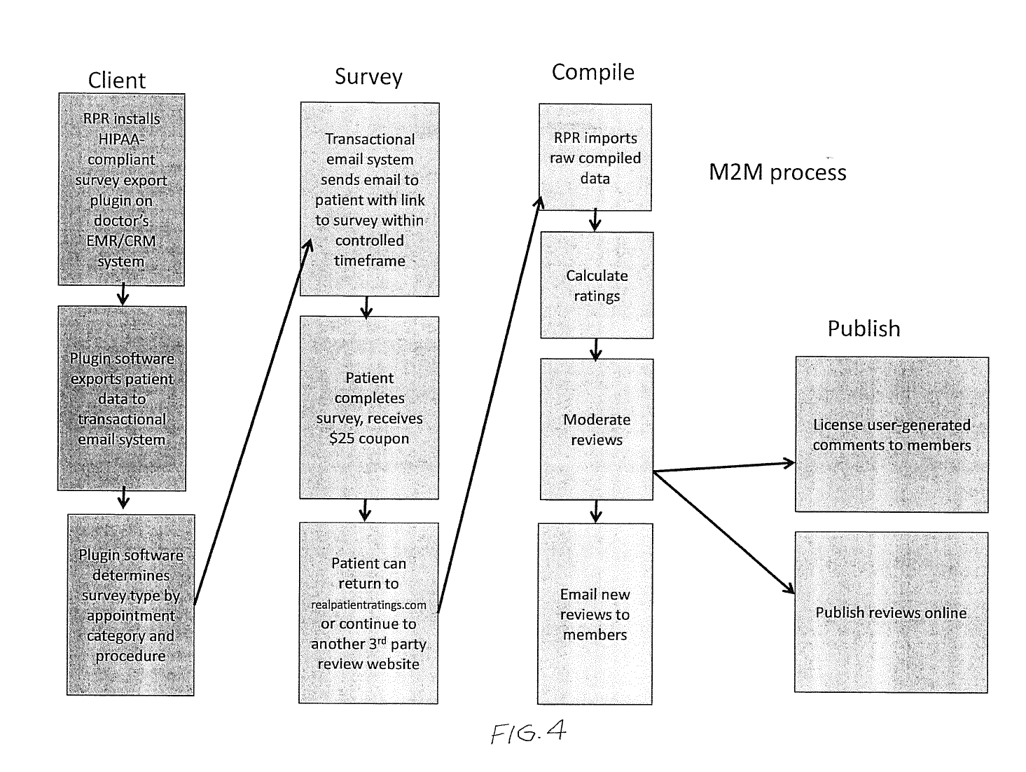

FIG. 3 illustrates a more specific example of a flowchart of a manual process in accordance with the generalized process illustrated in the flowcharts of FIGS. 16 and 17 of the drawings. FIG. 4 is a more specific example of a flowchart of a manufacturer to manufacturer process in accordance with the flowcharts of FIGS. 16 and 17 of the drawings.

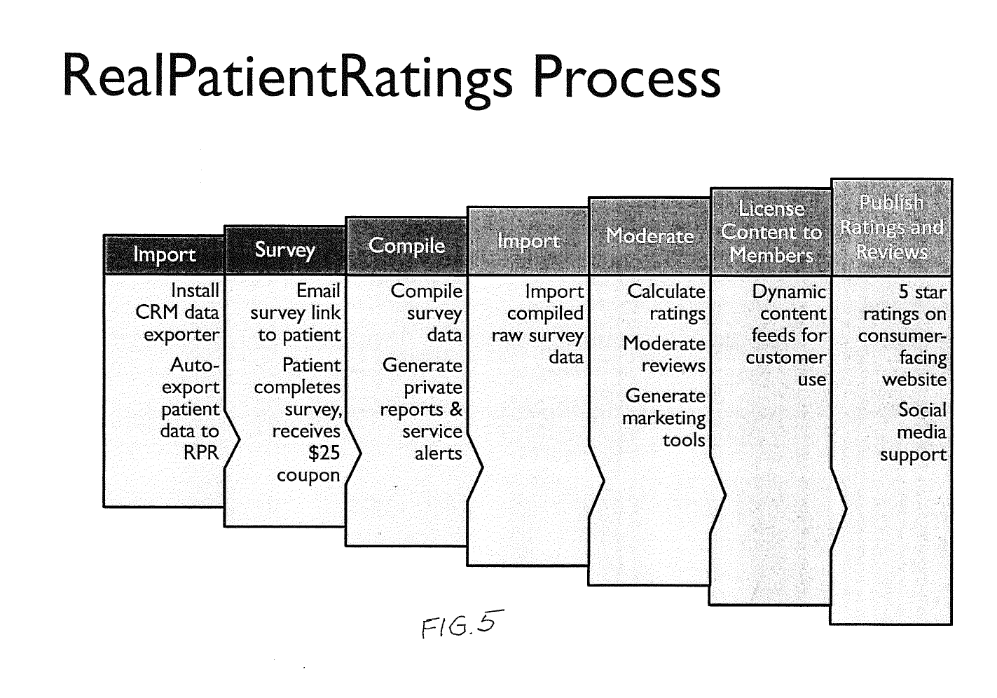

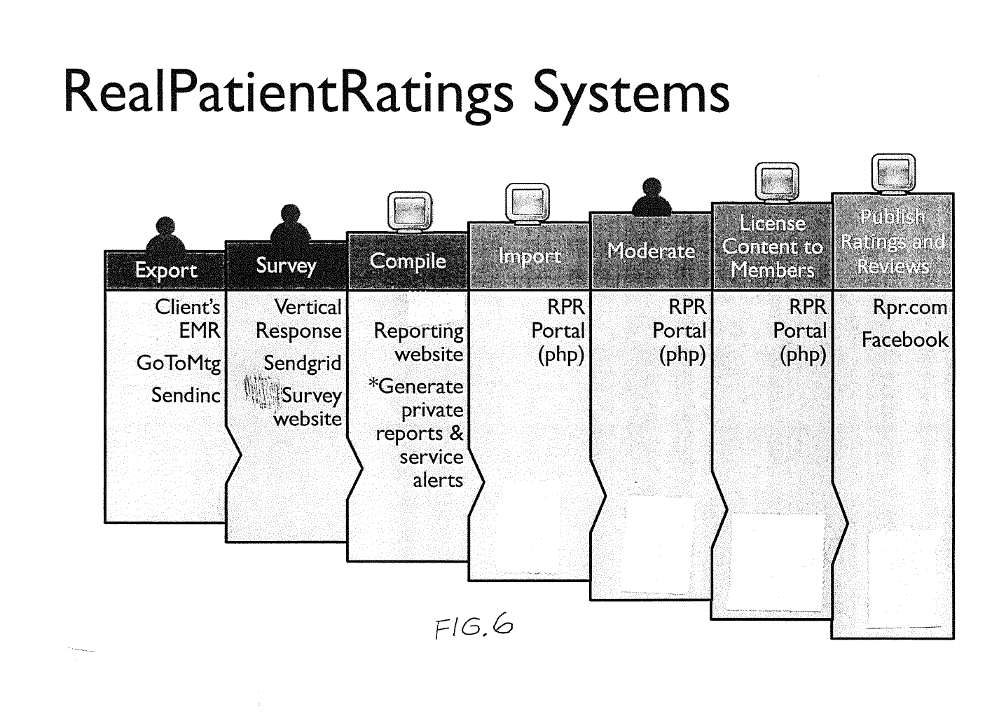

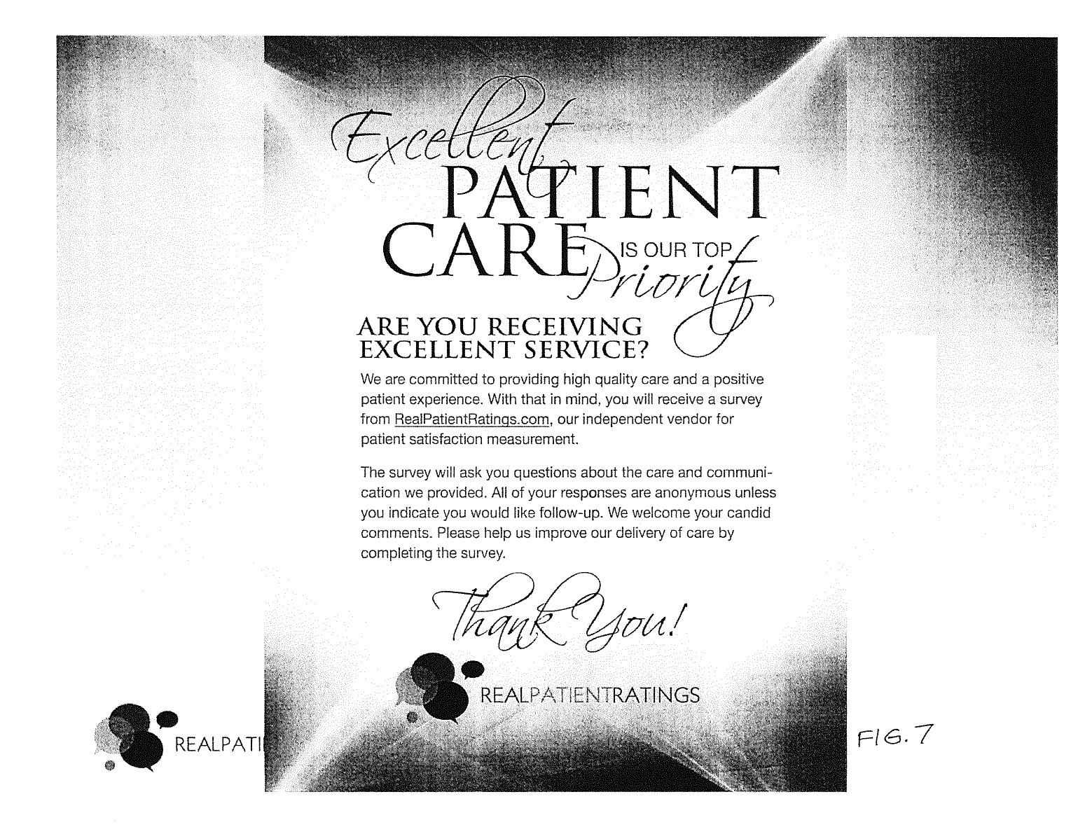

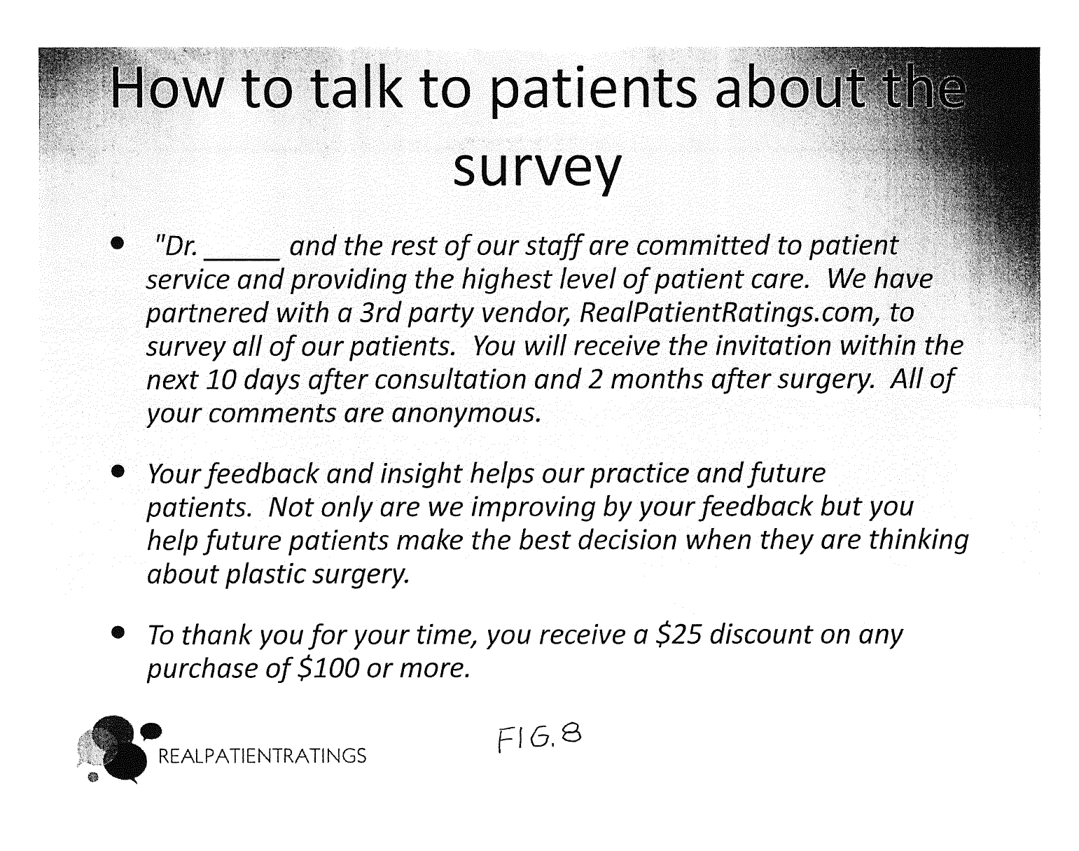

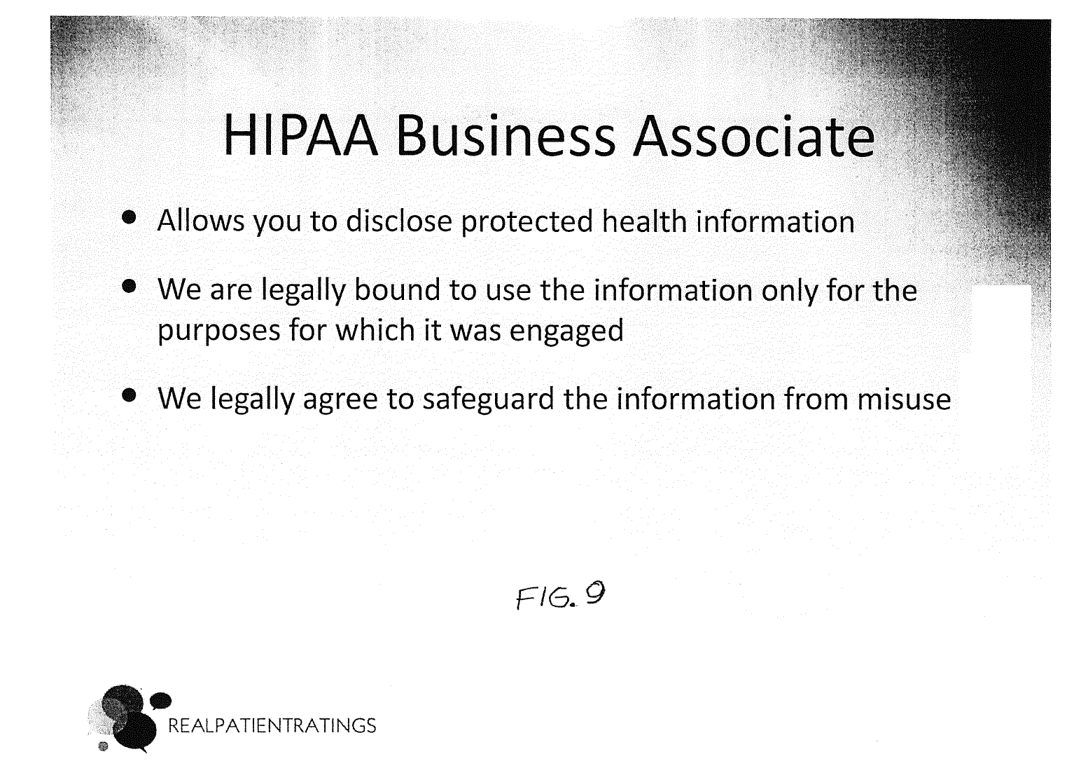

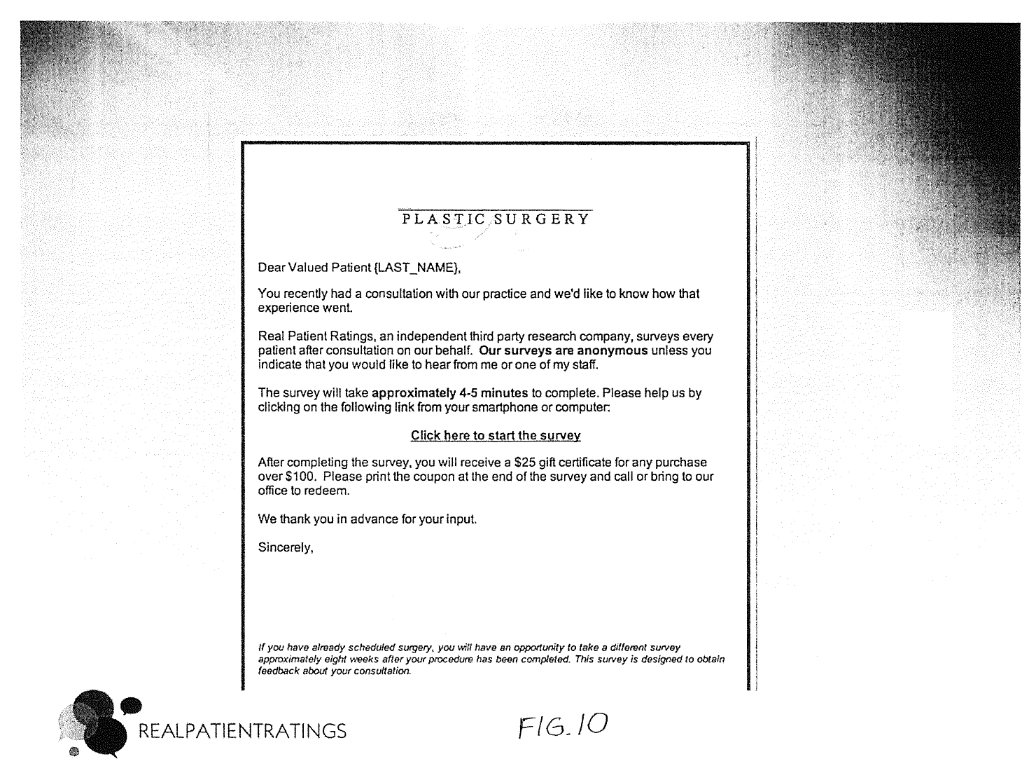

FIG. 5 is a diagram similar to the flowchart diagram of FIG. 3 illustrating the process according to the embodiments described herein. Similarly, FIG. 6 is a diagram which corresponds to the system 10 of FIG. 1. FIGS. 7 through 15 are screen shot illustrations generated by the third party real ratings portal computer 12 for display on consumer computers such as the consumer computers 32. FIG. 7 is an introductory screen shot concerning the rating service of the present embodiment. FIGS. 8 and 9 disclose examples of introductory screen shots inviting the consumer, in present example a patient, to provide survey information. FIG. 10 is a screen shot of a personalized letter to a patient who has decided to partake in the survey. It includes a link Click here to start the survey. By clicking on the link, the consumer is taken to the survey for enabling the consumer to take the survey.

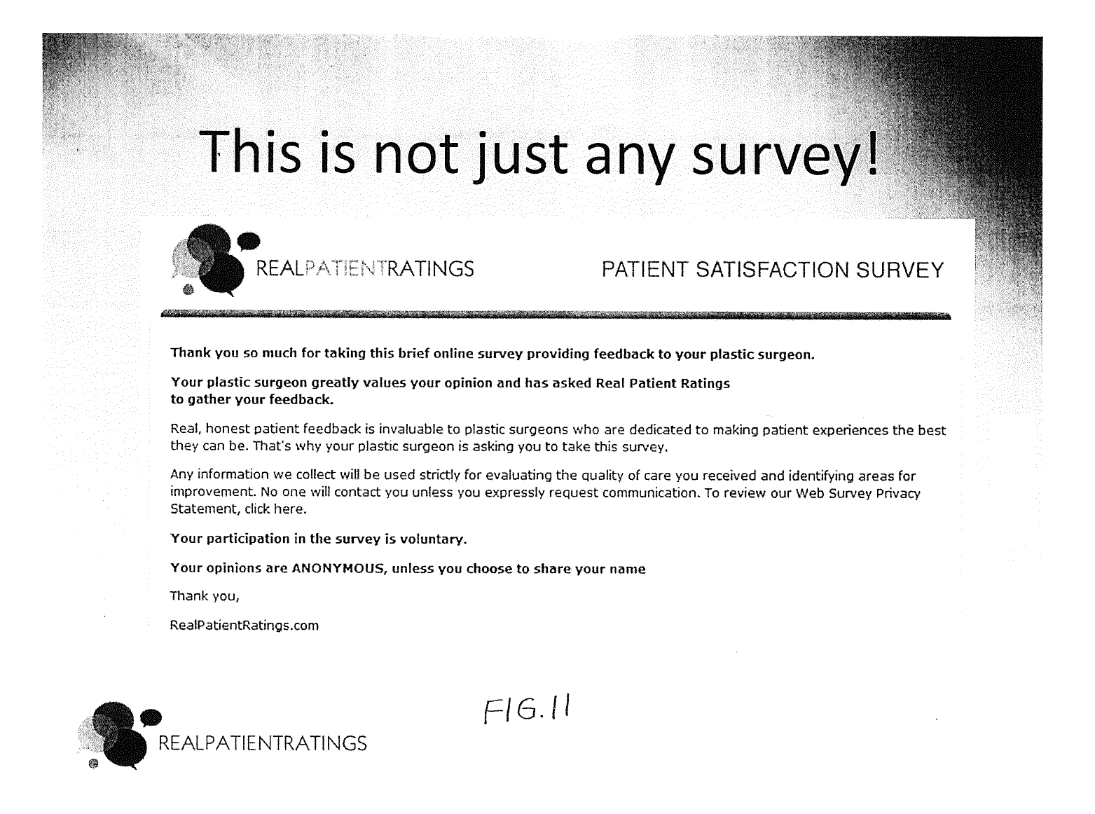

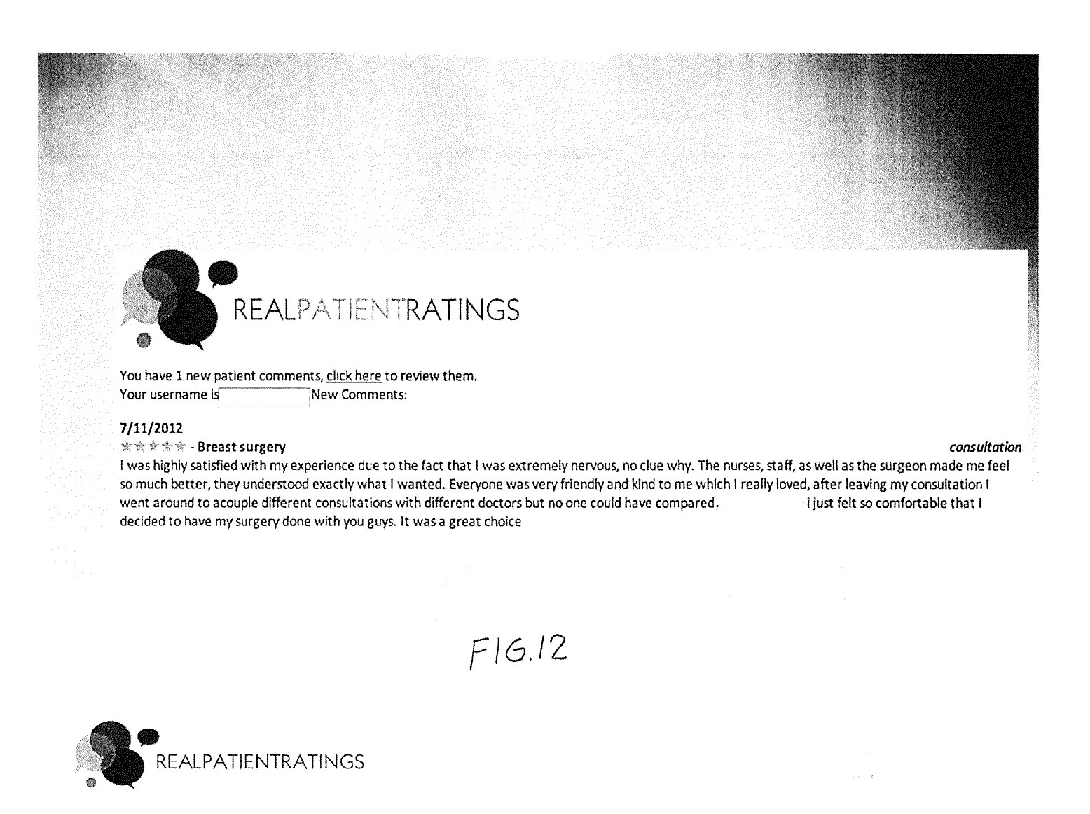

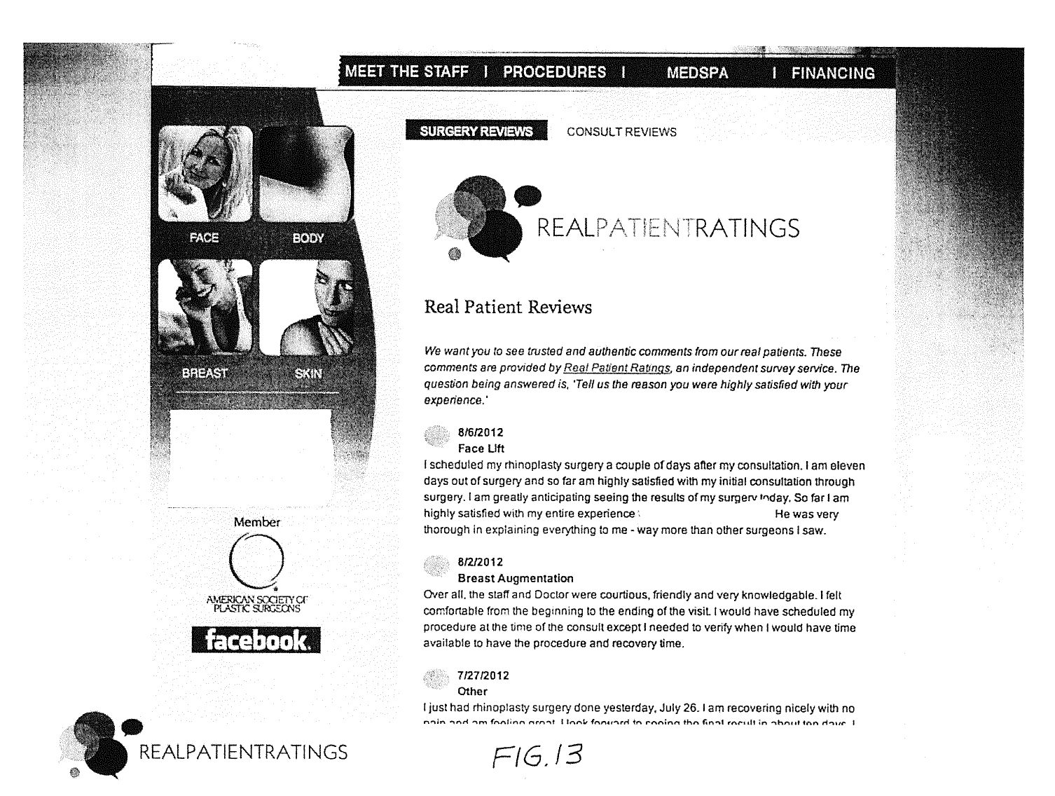

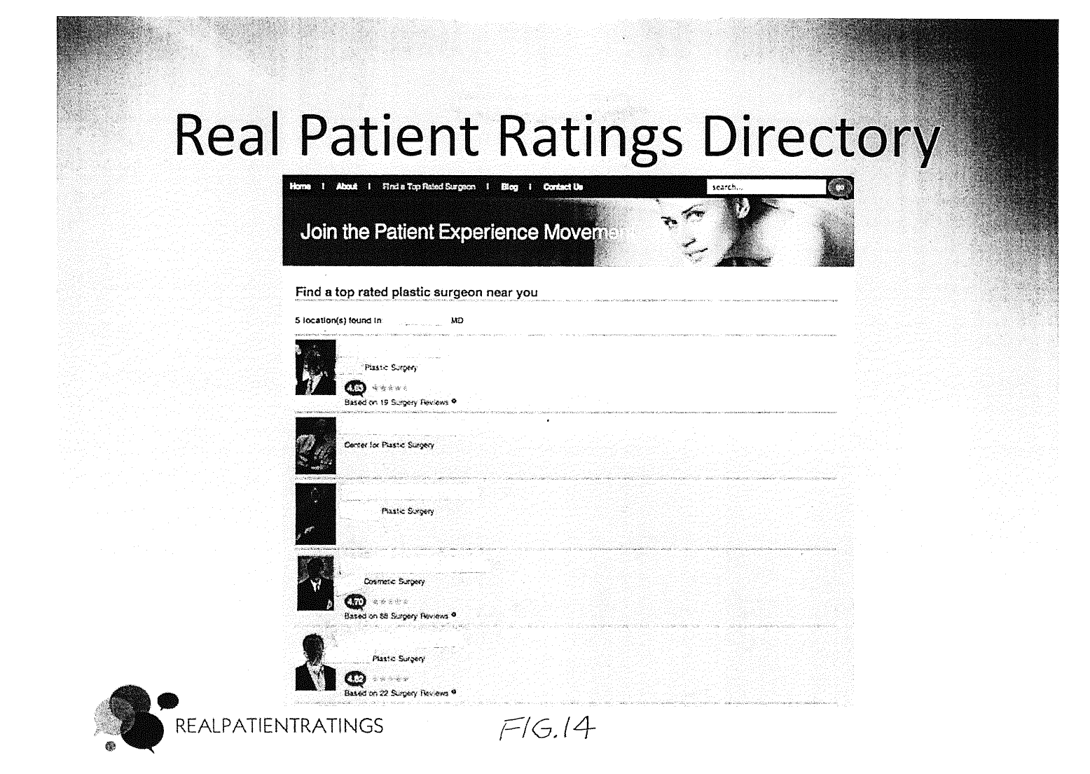

FIG. 11 is a screenshot for the patient once the survey is completed. FIG. 12 is a screenshot, or alternatively an email, which is displayed to the provider indicating that a new survey including a star rating is available for this provider. FIG. 13 is a screenshot illustrating a series of reviews for a given physician as displayed by the portal computer. FIG. 14 is a screenshot illustrating a group of doctors in response to a request in accordance with the system and method of the embodiment.

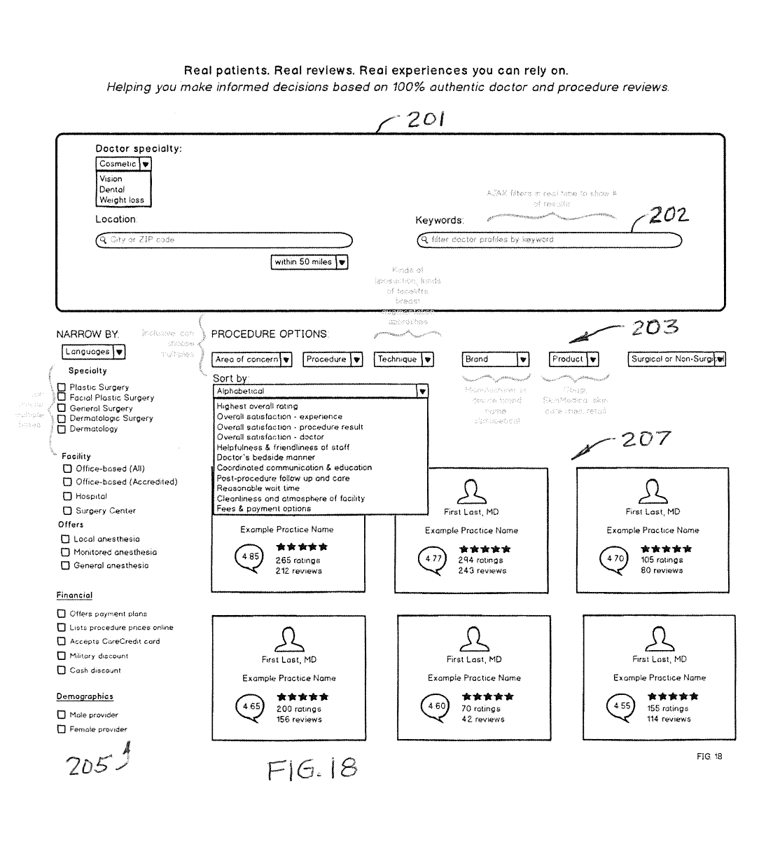

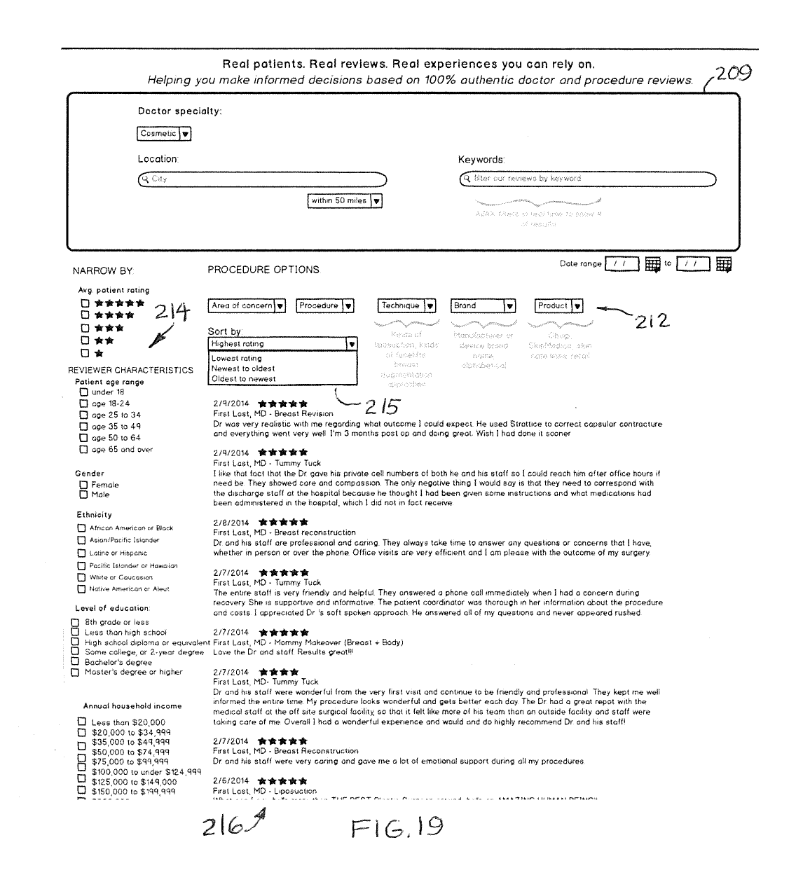

Referring now to FIGS. 18 and 19, the system 10 provides a technique to rate the goods and/or services of a given provider, as well as a rating for the provider as previously described. In this regard, the system 10 is able to enable a consumer to utilize the website of the system 10 to search for reviews for specific sub-categories of goods and/or services, either separate from or in addition to a search for a particular provider. While this feature may be used with the real ratings third-party system 10, it is contemplated that it may also alternatively be used with other conventional types of rating systems.

According to an embodiment, the real ratings portal computer software media causes the displaying of category preference information gathering indicia, and of sub-category preference information gathering indicia on its website. Thus, both category and sub-category preference information may be received from the consumer computer software of the consumer computers and stored in the portal computer. The portal computer searches the stored survey responses in response to the stored category and sub-category preference information. The portal computer displays the stored responses corresponding to the stored category and sub-category preference information.

The category preference information may include a search for keywords found in the survey responses so that a search may be made by the portal computer of the stored survey responses. In this manner, previously stored survey responses may be searched and then displayed on the website of the portal computer for viewing by a consumer using his or her consumer computer.

The sub-category preference information may include a plurality of high level types of sub-category information and a plurality of low level types of sub-category information. The high-level sub-category preference information may include a plurality of a variety of goods and/or services information. The low level sub-category preference information may include provider information. Thus, the portal computer searches both the high-level and the low-level sub-category preference information to search for either providers or survey responses, and then to display them on the portal computer website.

Referring now to FIG. 18, there is shown a screenshot for illustrating a procedure search feature where a consumer has undertaken a search for a provider who performs the desired procedure. Both preference categories and preference sub-category information may be utilized to find certain physicians for desired procedures. FIG. 18 of the drawings illustrates the example of a consumer seeking healthcare providers who perform certain cosmetic surgery fitting the preferences of the consumer as to certain selected preference information concerning categories and sub-categories of preference information.

The website screenshot of FIG. 18 illustrates certain general category preference information indicia indicated at 201 that enables the consumer to enter his or her general category preference information. This preference information includes the doctor specialty, the location of the doctor including the city and a selection of a certain radius of the city and a keyword search. A keywords box 202 enables the consumer to enter certain keywords which may be present in stored survey responses. This enables the portal computer to do a full text search of the stored survey responses for the selected keywords and thus retrieve selected survey responses or, in this case, certain physicians which respond to the selected keywords.

As indicated at 203, certain sub-categories may be selected by the consumer. There is a high level sub-category referred to as PROCEDURE OPTIONS which may be selected by the consumer. In this regard, the PROCEDURE OPTIONS may include an Area of concern, Procedures, Technique, Brand, Product, and Surgical or Non-Surgical, as well as others (not shown). The area of concern may include loose skin, moles, pigmentation and/or others. The procedures may include facelifts, liposuction and others. The technique may include the kinds of liposuction, kinds of facelifts, breast augmentation approaches, and/or others. The brand may include the manufacturer or device brand name, which may be listed alphabetically. The product may be Skin Medica, skin care lines, retail and/or others.

The high level sub-category selections are made by making either no selection or one or more selections in each high level sub-category. Once this is completed, the consumer may then make selections in the NARROW BY: low level sub-category preference information. This may include languages, Specialty, Facility, Offers, Financial, Demographics and/or others (not shown). Either no selections or one or more selections are made in each one of these low-level sub-category preferences.

Once the selections are made, as indicated in FIG. 18, at 207, illustrations of various physicians meeting both the selected low-level and high-level sub-category preference information are retrieved and displayed to the consumer. This information may include star ratings, photographs of the physician as well as the names of the physician illustrated. Other information may also be provided, such for example, as the number of ratings and the number of reviews.

Referring now to FIG. 19, there is shown another screenshot of the portal computer website to illustrate the ability of the portal computer 12 to enable a consumer to search for survey reviews stored in the portal computer 12. In the screenshot shown in FIG. 19, it is generally similar to the screenshot of FIG. 18.

A generalized category preference information gathering indicia 209 is similar to the generalized category indicia 201 of the screenshot illustrated in FIG. 18. Also, similar to the website screenshot illustrated in FIG. 18, is provided a PROCEDURE OPTIONS high level sub-category preference information gathering indicia 212 and a NARROW BY low-level sub-category preference information gathering indicia 214. In the present example as indicated in FIG. 19, a consumer using a consumer computer can select Cosmetic as the general category, and then select highest rating under a “Sort by” checkbox 215 for the procedure options sub-category to cause a search of the previously stored survey reviews for this category and sub-category. As indicated at 216, all those stored survey reviews responding to the selected category and sub-category are then retrieved and displayed to the consumer. The information displayed may also include a star rating as well as the date of the review.

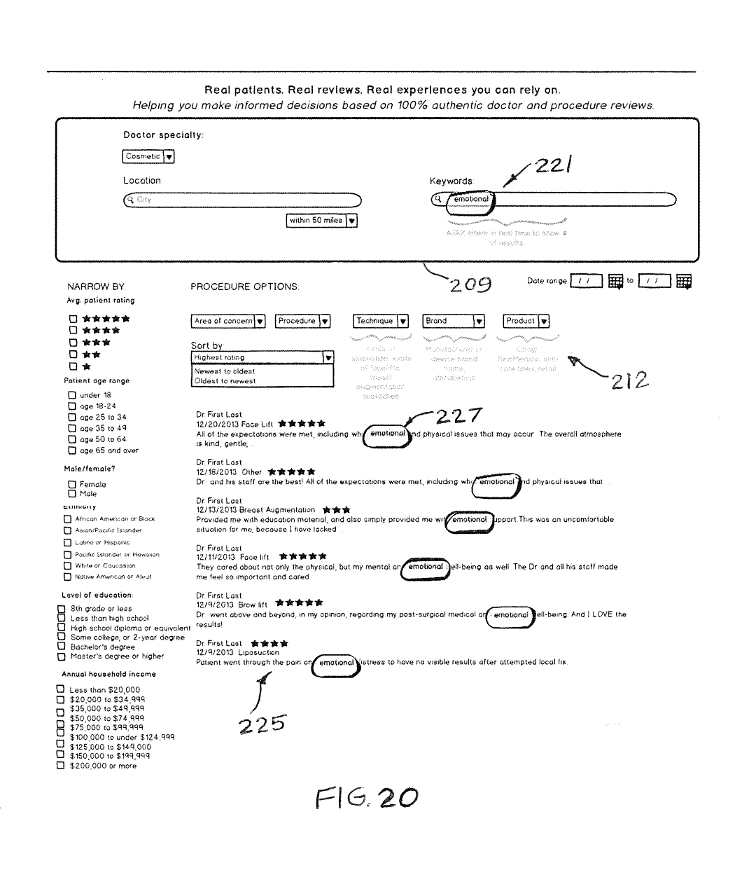

Referring now to FIG. 20, there is shown a screenshot of the portal computer website similar to the screenshot of FIG. 19, but adding a keyword to the selections by the consumer in the generalized indicia 209. A keyword “emotional” is indicated in the Keywords search box 221 for searching the previously stored survey responses for that word. The result is that a full text search is conducted by the portal computer 12 of the previously stored response surveys for the word “emotional” so that the survey search includes not only the generalized search indicia Cosmetic, the selection “Highest rating” for the sub-category 212, but also for the keyword “emotional” indicated at the box 221 for the keywords generalized category. Therefore, each one of the retrieved and displayed response surveys includes the word “emotional.”

While particular embodiments have been disclosed, it is to be understood that various different modifications and combinations are possible and are contemplated within the true spirit and scope of the disclosed embodiments. There is no intention, therefore, of limitations to the exact disclosure herein presented.

What is claimed is:

1. A system providing to consumer computers via a network, consumer satisfaction ratings by an independent third party rating service, the ratings concerning providers using provider computers, comprising:
a portal computer for requesting from a provider computer, consumer contact information for a consumer receiving goods and/or services from the provider;
the portal computer for receiving the consumer contact information from the provider computer and storing it in the portal computer;
the portal computer for sending a survey questionnaire to a consumer computer in response to the received consumer contact information;
the portal computer for receiving a response from the consumer computer in response to the survey questionnaire;
the portal computer for storing the response;
the portal computer for generating a proposed individual satisfaction rating based on the response;
the portal computer for sending the survey questionnaire response and the proposed individual satisfaction rating to the provider computer;
the portal computer for displaying on a portal independent third party website an authorized individual satisfaction rating for the consumer who received the goods or services from the provider; and
the portal computer for providing the authorized individual satisfaction rating to the provider computer.

2. A system according to claim 1, further including means for displaying on the independent third party website consumer ratings two or more authorized individual satisfaction ratings for two or more actual consumers who have received the goods or services from a variety of independent and distinct goods and/or services.

3. A system according to claim 1, wherein the survey questionnaire comprises a pre-purchase survey questionnaire.

4. A system according to claim 1, wherein the survey questionnaire comprises a post-purchase survey questionnaire.

5. A system according to claim 1, further including means for aggregating two or more proposed individual satisfaction ratings to create an aggregate satisfaction rating.

6. A system according to claim 5, further including means for displaying on the independent third party website the aggregate satisfaction rating for the consumers who received the goods or services from the providers.

7. A system according to claim 5, further including means for determining benchmarks based on two or more aggregate satisfaction ratings.

8. A computer system for providing consumer ratings, comprising:
a real ratings portal computer communicating with a provider computer via a network;
wherein the portal computer requests from the provider computer, consumer contact information for a consumer receiving goods and/or services from the provider;
wherein the portal computer receives the consumer contact information from the provider computer;
wherein the portal computer sends a survey questionnaire to the consumer computer in response to the received consumer contact information;
wherein the portal computer receives a response from the consumer computer in response to the survey questionnaire;
the portal computer communicating with a compiler computer;
wherein the compiler computer receives the response from the portal computer and stores the response;
wherein the portal computer generates a proposed individual satisfaction rating based on the response;
wherein the portal computer sends the survey questionnaire response and the proposed individual satisfaction rating to the provider computer;
the portal computer communicating with a website portal server;
wherein the website portal server receives from the portal computer an authorized individual satisfaction rating for the consumer who received the goods or services from the provider;
wherein the website portal computer displays the authorized individual satisfaction rating on the network; and
wherein the portal computer provides the authorized individual satisfaction rating to the provider computer.

9. A system according to claim 8, wherein the website portal server displays two or more authorized individual satisfaction ratings for two or more actual consumers who have received the goods or services from a variety of independent and distinct goods and/or services.

10. A system according to claim 8, wherein the survey questionnaire comprises a pre-purchase survey questionnaire.

11. A system according to claim 8, wherein the survey questionnaire comprises a post-purchase survey questionnaire.

12. A system according to claim 8, wherein the compiler computer aggregates two or more proposed individual satisfaction ratings to create an aggregate satisfaction rating.

13. A system according to claim 12, wherein the website portal computer displays on the independent third party website the aggregate satisfaction rating for the consumers who received the goods or services from the providers.

14. A system according to claim 12, wherein the compiler computer determines benchmarks based on two or more aggregate satisfaction ratings.

15. Software media for controlling a computer system for providing consumer ratings, comprising:
software media for controlling a real ratings portal computer communicating with software media controlling a provider computer via a network;
wherein the portal computer software media requests from the provider computer software media, consumer contact information for a consumer receiving goods and/or services from the provider;
wherein the portal computer software media receives the consumer contact information from the provider computer software media;
wherein the portal computer software media sends a survey questionnaire to software media controlling a consumer computer in response to the received consumer contact information;
wherein the portal computer software media receives a response from the consumer computer software media in response to the survey questionnaire;
the portal computer software media communicating with software media controlling a compiler computer;
wherein the compiler computer software media receives the response from the portal computer software media and stores the response;
wherein the portal computer software media generates a proposed individual satisfaction rating based on the response;
wherein the portal computer software media sends the survey questionnaire response and the proposed individual satisfaction rating to the provider computer software media;
the portal computer software media communicating with software media controlling a website portal server;
wherein the website portal server software media receives from the portal computer software media an authorized individual satisfaction rating for the consumer who received the goods or services from the provider;
wherein the website portal computer software media displays the authorized individual satisfaction rating on the network; and
wherein the portal computer software media provides the authorized individual satisfaction rating to the provider computer software media.

16. Software media according to claim 15, wherein the website portal server software media displays two or more authorized individual satisfaction ratings for two or more actual consumers who have received the goods or services from a variety of independent and distinct goods and/or services.

17. Software media according to claim 15, wherein the survey questionnaire comprises a pre-purchase survey questionnaire.

18. Software media according to claim 15, wherein the survey questionnaire comprises a post-purchase survey questionnaire.

19. Software media according to claim 15, wherein the compiler computer software media aggregates two or more proposed individual satisfaction ratings to create an aggregate satisfaction rating.

20. Software media according to claim 19, wherein the website portal computer software media displays on the independent third party website software media the aggregate satisfaction rating for the consumers who received the goods or services from the providers.

21. Software media according to claim 19, wherein the compiler computer software media determines benchmarks based on two or more aggregate satisfaction ratings.

22. A system according to claim 1, wherein the real ratings portal computer software media causes the displaying of category preference information gathering indicia, and of sub-category preference information gathering indicia, and enables both category and sub-category preference information to be received from the consumer computer software and stored in the portal computer;
wherein the portal computer searches the stored survey responses in response to the stored category and sub-category preference information; and
wherein the portal computer displays the stored responses corresponding to the stored category and sub-category preference information.

23. A system according to claim 22, wherein the category preference information includes keywords.

24. A system according to claim 22, wherein the sub-category preference information includes a plurality of high level types of sub-category information and a plurality of low-level types of sub-category information.

25. A system according to claim 24, wherein high level sub-category preference information includes a plurality of goods or services information.

26. A system according to claim 24, wherein the low level sub-category preference information includes provider information.

27. A system according to claim 22, wherein the portal computer searches include provider searches for display.

28. A system according to claim 22, wherein the portal computer searches include survey responses for display.
